(19) United States
(12) Patent Application Publication
(10) Pub. No.: US 2025/0376054 A1
(43) Pub. Date: Dec. 11, 2025

(54) Locking Device For Locking A Loading Plug In A Loading Socket

(71) Applicant: Lisa Draexlmaier GmbH, Vilsbiburg (DE)

(72) Inventor: Annika Krebs, Landshut (DE)

(73) Assignee: Lisa Draexlmaier GmbH, Vilsbiburg (DE)

(21) Appl. No.: 19/296,048

(22) Filed: Aug. 11, 2025

(30) Foreign Application Priority Data
Jun. 11, 2024 (DE) 102024116317.8

(51) Int. Cl. B60L 53/16; H01R 13/629

(52) U.S. Cl. CPC B60L 53/16; H01R 13/629

(57) ABSTRACT

A locking device for locking a charging plug in a charging socket is disclosed. The locking device includes at least one locking element designed to be moved into a charging plug locking position in which the at least one locking element releasably locks a charging plug inserted into a charging socket. The at least one locking element is further designed to be moved into a charging plug release position in which the at least one locking element releases the charging plug for release from the charging socket. An electronically actuated actuator is provided. The actuator is designed to move the at least one locking element between the charging plug locking position and the charging plug release position. An emergency release device is provided and designed to move the at least one locking element independently of actuator at least from the charging plug locking position to the charging plug release position.

### CROSS REFERENCE TO RELATED APPLICATIONS

This application claims priority to German patent application 102024116317.8, filed Jun. 11, 2024, the content of which is herein incorporated by reference.

### BACKGROUND OF THE INVENTION

### Field of the Invention

The invention relates to a locking device for locking a charging plug in a charging socket, preferably in a charging socket of a vehicle that is at least partially electrically powered. The invention also relates to a charging socket, preferably a charging socket of a vehicle that is at least partially electrically powered, with such a locking device, as well as a method for operating such a locking device.

### Description of Related Art

Energy storage devices are used in a wide range of applications, such as electric vehicles, but also in other industrial areas. In the field of electric vehicles, these energy storage devices are often referred to as traction batteries, traction battery systems, or simply as batteries or battery systems. The battery systems used in electric vehicles are usually accumulators, in particular lithium-ion accumulators. These energy storage devices are usually charged via a charging socket, often referred to in connection with electric vehicles as an “inlet,” “charging inlet,” or “charge port inlet,” which serves as an interface for connecting a charging plug, often referred to simply as a “connector,” from a charging cable.

In electric vehicles, a particular challenge is that during longer charging processes at publicly accessible charging stations, the charging plug may be removed from the charging socket without authorization or unintentionality. Various plug locking devices have been developed to solve this problem, which serve as plug pull-out safeguards. These locking devices are available in different designs, including mechanical and/or electronic locking mechanisms.

The NACS standard (North American Charging Standard) is an example of a common standard with an electronic locking mechanism. When the charging plug is inserted into the charging socket, a sensor in the charging socket detects the presence of the plug. An electronic signal is sent to an actuator, which activates the plug locking device of the locking mechanism, for example with the aid of an electromagnet or an electric motor. Specifically, the actuator moves an actuator pin that acts as a locking element, thereby securing the charging plug in the charging socket. This prevents the charging plug from being removed during the charging process. During the entire charging process, a control unit monitors the connection and ensures that the lock remains active. As soon as the charging process is complete or the vehicle is unlocked, the control unit sends a signal to the actuator, which releases the mechanical lock and unlocks the charging plug. The actuator pin is moved between a charging plug release position and a charging plug locking position, for example in such a way that, in the charging plug locking position, the actuator pin is guided from the outside through a recess in a wall area of the charging socket into the receiving area or plug receiving area of the charging socket, where the actuator pin interacts with a counter element of a charging plug connected to the charging socket in such a way that the charging plug is releasably locked. In the charging plug release position, however, the actuator pin is retracted in such a way that it no longer interacts with the counter element and the charging plug is thus released.

If the actuator malfunctions in the charging plug locking position with a blocked actuator element, there is a risk that the charging plug cannot be removed without extensive professional work, which ultimately means that the vehicle is not roadworthy.

In addition, the actuator with its controllably extendable actuator element is often arranged below the load connector in relation to the vertical axis direction in the operating position of the load connector so that the recess through which the actuator pin is guided can also function as a drain opening for dripping liquids, such as water. However, this arrangement below the load box in turn promotes a malfunction of the actuator, as the dripping liquid can then drip directly onto the actuator and possibly damage it.

### BRIEF SUMMARY OF THE INVENTION

An objective of the present invention is to further develop a locking device for locking a charging plug in a charging socket, preferably in a charging socket of an at least partially electrically operated vehicle, in such a way that the functional reliability of the plug lock is further improved.

This task is solved by the features of the independent claims. Advantageous further developments of the invention are indicated in the subclaims, the following description, and the figures.

According to the invention, a locking device is provided for locking a charging plug in a charging socket. Such a charging socket is, for example, a component of an at least partially electrically powered vehicle, such as an at least partially electrically powered passenger car or an at least partially electrically powered commercial vehicle, and is used there, for example, to charge an energy storage device of the vehicle, which, as already mentioned at the beginning, is also referred to as a traction battery or traction battery system or battery or battery system. However, the locking device according to the invention can also be used in conjunction with other industrial applications where charging sockets are used to charge energy storage devices.

The charging socket can be detachably connected to the charging plug, which is preferably arranged on a charging cable, which is why the locking device has at least one locking element that is designed to be moved into a charging plug locking position in which the at least one locking element detachably locks a charging plug inserted into the charging socket, and which is further designed to be moved into a charging plug release position in which the at least one locking element releases the charging plug for release from the charging socket.

Furthermore, an electronically controllable or actuable actuator is provided, which is designed to move the at least one locking element between the charging plug locking position and the charging plug release position. The electronic control of the actuator is preferably carried out by means of a control device or an electronic control system.

In addition, an emergency release device is provided which is designed to move the at least one locking element independently of actuator actuation at least from the charging plug locking position to the charging plug release position.

The advantage of such an emergency release device, which can move the locking element independently of actuator actuation at least from the charging plug locking position to the charging plug release position, lies primarily in the safety and reliability of the charging process. This functionality allows the locking element to be opened manually or by other means that do not rely on the electronic control. This means that in the event of a failure of the actuator or the electronic control, the charging plug can still be removed safely, for example to unlock the vehicle and/or complete the charging process properly. It provides a backup method in the event of system failures and thus increases the overall safety and reliability of the charging system.

For the reliable operation of the locking device, it is generally and exemplarily advantageous if the actuator is designed so that it automatically moves the locking element into the charging plug locking position when the charging plug is inserted into the charging socket and automatically moves the locking element into the charging plug release position when the charging plug is removed from the charging socket. These movements are triggered by electronic control signals that instruct the actuator to move to the respective position. The connection and release of the plug is detected, for example, by sensors that detect the correct connection and removal of the plug and send a corresponding signal to the control unit.

According to a particularly preferred further development, the emergency release device is designed to move at least one locking element independently of actuator operation both from the charging plug locking position to the charging plug release position and from the charging plug release position to the charging plug locking position. It may well be useful to provide an emergency release device that can move the locking element not only from the charging plug locking position to the charging plug release position, but also from the charging plug release position to the charging plug locking position. This offers several advantages: if the actuator or the electronic control system fails, the locking element could remain in the charging plug release position, which poses a safety risk as the plug could be accidentally removed during the charging process. An emergency release device that can also move the locking element to the charging plug locking position ensures that the plug can still be securely locked even in the event of a system failure. In addition, technicians and maintenance personnel may need the ability to manually move the locking element to both positions in order to diagnose the system and ensure that the locking device is functioning properly, which is particularly useful during maintenance or troubleshooting.

According to a further particularly preferred embodiment, the actuator is provided with a movable actuator element, for example an actuator pin, which is releasably connected to the locking element by means of an emergency release connecting element of the emergency release device for joint displacement of the actuator element and the locking element between the charging plug release position and the charging plug locking position. Furthermore, the emergency release connecting element is designed be moved or displaced into a release or emergency release position in which the connection between the actuator element and the locking element is separated or released and the locking element can be transferred or is transferred to the charging plug release position, preferably essentially automatically to the charging plug release position. Specifically, this can be implemented, for example, by designing the emergency release connecting element so that, starting from a mounted basic position in which the locking element is firmly connected to the actuator element but releasably connected to the actuator element and, together with the latter, can be moved between the charging plug release position and the charging plug locking position by means of the actuator, in particular for emergency release in the event of a malfunction of the actuator in the charging plug locking position with the actuator element blocked and the charging plug inserted, to be moved into a release or emergency release position in which the connection between the actuator element and the locking element is disconnected or released and the locking element can be transferred or is transferred to the charging plug release position, preferably essentially automatically to the charging plug release position.

Specifically, it may also be provided, for example, that the charging socket has a charging socket housing with a charging socket front side having plug contacts, wherein it is preferably provided that the actuator is arranged on the charging socket housing and/or that the at least one locking element is arranged in the charging socket housing. This creates an advantageous structural unit which also makes it possible to arrange access to the emergency release device in places that are difficult to access or difficult to see, so that it is only actually actuated in emergencies, for example in conjunction with studying the instructions for use.

According to a particularly advantageous embodiment, it is also advantageous if the charging socket housing has at least one defined emergency release access via which the emergency release connecting element is accessible for actuation, preferably for manual actuation and/or for actuation with a tool. This emergency release access may, for example, be formed by at least one lockable or unlockable opening or, as already mentioned above, be arranged in a simple manner at a location that is difficult to access or not easily visible in order to prevent tampering. Accordingly, in a particularly preferred embodiment, the emergency release access is provided on a wall of the charging socket facing away from the front of the charging socket, preferably on a rear wall of the charging socket facing away from the front of the charging socket.

Preferably, it should be possible to unlock the device without special knowledge and, if necessary, with a simple tool, such as a screwdriver. Alternatively, the emergency release device could also be operated in another way, for example by means of a Bowden cable connection. This would then allow the emergency release to be operated from a location offset from the charging socket.

According to a particularly preferred specific design, which ensures that the charging plug is securely locked in the charging socket, the locking element, which is preferably lance- and/or rod-shaped and most preferably formed by a locking rod, has a locking element, for example in the form of a snap-in lug or locking pawl, which, in the charging plug locking position, engages in a locking counter-element on a charging plug inserted into the charging socket as a plug pull-out safety device by means of a recess on the charging socket wall in the receiving area of the charging plug, or cooperates with the latter in a locking and/or interlocking manner, wherein the locking element is displaced from the area of the locking counter-element, in particular from the charging socket, in the charging plug release position. In this context, it is also particularly advantageous if the locking element can be displaced, for example, optionally with its locking element by means of the connected actuator element linearly in a linear guide or by pivoting about a pivot axis or by rotating about a rotation axis or by a multi-joint arrangement in such a way that the locking element engages through the recess on the charging socket wall into the locking counter element of an inserted charging plug.

The actuator and/or the actuator element can, depending on the available installation space and the specific design specifications, be arranged anywhere, i.e. relative to the position of use of the charging socket and viewed in the vertical axis direction, at the top or bottom or on the side of the charging socket or on the charging socket housing. The actuator element can then be extended or retracted depending on the specific position of the actuator in the charging plug locking position.

If, for example, the actuator is located at the bottom of the charging socket or on the charging socket housing and is therefore exposed to dripping water, sealing measures can be used to protect the actuator accordingly. According to an exemplary alternative embodiment, the actuator and/or the actuator element, relative to the position of use of the charging socket and viewed in the vertical axis direction, may also be arranged above the locking element. This arrangement prevents water from dripping from the charging socket onto the actuator and causing malfunctions. This design also makes it particularly easy to implement an emergency release function: when the emergency release connecting element is actuated or moved, particularly in the event of a malfunction of the actuator in the charging plug locking position with the actuator element blocked and the charging plug inserted, it is then possible to ensure in an emergency release position in a simple manner that that not only is the actuator element released from the locking element, but that the locking element, after being released from the actuator element, can preferably drop down essentially automatically and thus be moved essentially automatically into the charging plug release position, in which the charging plug is released for removal from the charging socket.

This can be achieved, for example, with a specific and optional design in which the locking element, preferably inside the charging socket, most preferably inside the charging socket housing, is guided downward from the actuator and/or the actuator element and engages beneath a receiving area of the charging socket, preferably of the charging socket housing, which receives the charging plug, in such a manner that the locking element releasably locks an inserted charging plug from below, wherein it is preferably provided that the locking element can be displaced in the emergency release position after being released from the actuator element, preferably automatically or essentially automatically falling downwards, thereby moving the locking element into the charging plug release position. According to a particularly preferred and structurally simple optional embodiment, it can be provided, for example, that a locking element of the locking element already described above is passed through a recess in the lower side of the charging plug receiving area in the charging plug locking position and releasably locks an inserted charging plug, so that the locking element can be moved downward in the emergency release position after being released from the actuator element, preferably falling downward automatically or essentially automatically. With such a design, it is specifically achieved that, in the charging plug locking position, the actuator element, together with the locking element, is displaced upward as viewed from the actuator, so that the locking element engages from below through the recess in the charging plug receiving area into a locking counter element of an inserted charging plug or cooperates with it in a locking manner. Various undercut shapes, such as webs, recesses, etc., can be used as locking counter elements on the charging plug for engagement of the locking element.

According to a further particularly preferred embodiment, which is easy to manufacture with a compact design and ensures reliable actuator operation, it can also be provided here as an option and by way of example that the locking element, starting from the actuator and/or actuator element, preferably in the vertical axis direction or vertically in a linear guide, and engage with it from below, for example with a hook area.

Furthermore, for a compact design, it is advantageous, for example, if the locking element is arranged at the end and/or protrudes upwards.

In principle, there are various possibilities for coupling or connecting the actuator element to the locking element by means of the emergency release connecting element. According to a particularly easy-to-manufacture and functionally reliable embodiment, it can be provided, for example, that the actuator element, which is preferably formed by an actuator pin, is first inserted into a receiving opening of the locking element and is releasably received there, and that the two components are then finally connected or locked together during final assembly by means of the emergency release connecting element. The primary releasable reception in the receiving opening is achieved, for example, with a clearance so that when the emergency release connecting element is actuated or displaced, it is ensured that the actuator element or the actuator pin is released from the locking element and can, for example, fall down.

According to a particularly preferred specific embodiment, which is characterized by a compact design, simple manufacture, and very high functional reliability, the emergency release connecting element is formed by a sliding bolt that is held and/or mounted in a manner that allows it to be displaced on the locking element and which, in a sliding bolt connection position, connects the actuator element to the locking element for joint displacement and, in a locking position, connects the actuator element to the locking element for disconnection, in particular for disengagement of the connection between the actuator element and the locking element, the connection position connecting the actuator element to the locking element for joint displacement and which can be moved into a slide bolt release position corresponding to the emergency release position in order to release the connection between the actuator element and the locking element, in particular for emergency release.

According to an optional specific further development in this regard, it may be provided, for example, that the locking element designed as a sliding bolt engages in the sliding bolt connection position in a sliding bolt recess of the actuator element, preferably in a sliding bolt recess designed as a transverse groove, and thereby connects the actuator element to the locking element, wherein the locking element can be moved into the emergency release position, which corresponds to the sliding bolt release position, in which the sliding bolt can be disengaged from the sliding bolt recess, in order to release the connection between the actuator element and the locking element, in particular for emergency release. This is achieved, for example, with a structure in which the sliding bolt has a bolt part which itself has a contour with a first section and a second section adjoining the first section and narrower than the first section. In the slide bolt connection position, the first, wide section can then engage in the slide bolt recess on the actuator element, which is preferably formed on the side, to establish a connection. If, on the other hand, the sliding bolt is moved into the sliding bolt release position, the first section disengages from the sliding bolt recess on the actuator element, while the second, narrower section now lies in the area of the sliding bolt recess. This second, narrower section is dimensioned such that, in the slide bolt release position, it disengages from the actuator element and releases the connection between the locking element and the actuator element, in particular for emergency release. The locking part itself can be designed in a simple manner, for example by means of a preferably flat locking part extending from the slide bolt slide section as an extension.

In order to be able to mount the locking device simply and reliably, a further particularly preferred embodiment provides that the emergency release connecting element, preferably on its side facing away from the emergency release access, has a mounting element which is designed to be gripped, for example by a worker, in order to pre-position the emergency release connecting element on the locking element and/or to move the emergency release connecting element, preferably after its pre-positioning and/or the coupling of the actuator element to the locking element, into the sliding bolt connection position, which releasably connects the actuator element and the locking element.

In addition, for a space-saving and compact design of the locking device, it may be provided that the emergency release connecting element, which is designed as a sliding bolt, is held and/or mounted in a guide groove of the locking element so that it can be displaced, it being preferably provided that the guide groove, relative to the position of use of the loading box and viewed in the vertical axis direction, is horizontally aligned.

According to a particularly preferred optional and exemplary embodiment, which is easy to manufacture and is characterized by a high level of functional reliability, the guide groove can be formed in the upper region of the locking element facing the actuator, as viewed in relation to the position of use of the loading box and in the vertical axis direction, which is preferably formed by a horizontal guide part region.

Alternatively, or in addition to this, in order to increase functional reliability, a slide bolt slide section of the emergency release connecting element designed as a slide bolt may be guided laterally on the locking element, supported by web elements. For a compact design, it may also be provided in this context that the mounting element is also arranged on the slide bolt slide section, if necessary.

According to a further particularly preferred embodiment, which increases the functional reliability and operation of the emergency release device, it may optionally be provided that the emergency release connecting element designed as a slide bolt has an emergency release actuating element, preferably on its side facing the emergency release access. This emergency release actuating element can, for example, form and/or have an emergency release tool attachment. According to a particularly preferred embodiment, which is characterized by a compact and simple design, the emergency release actuating element is designed, for example, in the form of a bracket or leg projecting upward from the sliding bolt in the vertical axis, which is preferably and exemplarily connected to the sliding bolt slide section already described above.

To increase ease of use, it can also be provided as an option that at least one marking is affixed to the emergency release actuating element of the emergency release connecting element designed as a slide bolt and/or to the locking element, which marking is designed visually indicate a position of the emergency release connecting element designed as a sliding bolt in the charging plug locking position or in the charging plug release position, preferably through the emergency release access.

In particular, in order to prevent unintentional actuation of the emergency release device, it is advantageous if the sliding bolt is held immovably on the locking element and thus in the sliding bolt connection position by means of the emergency release actuating element in the assembled basic state. In addition, in this installed basic state, the emergency release actuating element is held on the locking element in a relative displacement direction that does not correspond to the sliding bolt displacement direction, preferably against an elastic preload force. Finally, the emergency release actuating element is further designed such that, in the event of a relative displacement of the emergency release actuating element relative to the locking element caused, for example, by the application of force, preferably by overcoming the elastic preload, caused on the emergency release actuating element relative to the locking element, the sliding bolt is released by means of the emergency release actuating element into the sliding bolt release position. Based on this, the further displacement of the slide bolt into the slide bolt release position can then be carried out by means of the emergency release actuating element.

According to a particularly preferred specific embodiment of the present invention, which is easy to manufacture and also significantly increases the functional reliability of the emergency release device as a whole, it can be optionally provided, for example, that the emergency release actuating element engages the locking element, preferably a guide part region of the locking element, relative to the position of use of the loading box and viewed in the vertical axis direction, from above on a guide web, preferably with a U-shaped leg, wherein a locking lug is formed on the guide web engaged by the emergency release actuating element, behind which the emergency release actuating element, preferably the U-shaped leg of the emergency release actuating element, engages elastically in the assembled basic position. The emergency release actuating element can then be displaced relative to the locking element for unlocking, in particular for emergency release, by applying a force, in particular a compressive force, to the emergency release actuating element, in particular by overcoming the preload, so that the U-shaped leg can be lifted via the locking lug and thus the emergency release connecting element designed as a sliding bolt can be moved further into the load connector release position by means of the emergency release actuating element.

The emergency release actuating element is also advantageously designed here as an emergency release tool attachment or has such an emergency release tool attachment, so that the emergency release can be carried out easily using a suitable tool, for example a screwdriver.

A task according to the invention is further solved by a charging socket with a locking device as described above. The advantages resulting from the charging socket according to the invention are identical to those already mentioned in connection with the locking device. In this respect, reference is made to the above explanations in order to avoid repetition.

A task of the invention is further solved by a method for actuating a locking device for locking a charging plug in a charging socket, in particular a locking device as described above, in which at least one locking element is provided which is designed to be moved into a charging plug locking position in which the at least one locking element engages in the charging socket, in which the locking element is designed to be moved into the locking position by a charging plug inserted into the charging socket, and in which the locking element is designed to be moved into the locking position by a charging plug inserted into the charging socket, to be moved into a charging plug locking position in which the at least one locking element releasably locks a charging plug inserted into the charging socket, and which is further designed to be moved into a charging plug release position in which the at least one locking element releases the charging plug for release from the charging socket.

Furthermore, an electronically actuated actuator is provided, which is designed to move the at least one locking element between the charging plug locking position and the charging plug release position.

Furthermore, an emergency release device is provided, by means of which the at least one locking element is moved from the charging plug locking position to the charging plug release position for emergency release independently of actuator actuation.

The advantages resulting from the method according to the invention are identical to those already mentioned in connection with the locking device. In this respect, reference is made to the above explanations to avoid repetition.

### BRIEF DESCRIPTION OF THE SEVERAL VIEWS OF THE DRAWINGS

Further advantages, features, and details of the various embodiments of this disclosure will become apparent from the ensuing description of a preferred exemplary embodiment and with the aid of the drawings. The features and combinations of features recited below in the description, as well as the features and feature combination shown after that in the drawing description or in the drawings alone, may be used not only in the particular combination recited, but also in other combinations on their own, without departing from the scope of the disclosure.

An advantageous embodiment of the present invention is set out below with reference to the accompanying figures, wherein:

FIG. 1 depicts a schematic perspective partial view of an exemplary embodiment of a locking device arranged on a charging socket;

FIG. 2 depicts an emergency release connecting element designed as a sliding bolt;

FIG. 3 depicts a front view of the cartridge case housing according to FIG. 1;

FIG. 4 depicts the loading box housing according to FIG. 3 without front wall with locking device mounted on the inside of a rear wall;

FIG. 5 depicts a perspective view of the charging box housing according to FIG. 4 in a pre-assembled state with a slide lock that is not yet locked;

FIG. 5b depicts a detailed view of detail A from FIG. 5a, showing the slide bolt in the unlocked state;

FIG. 5c depicts a schematic detailed view of a window opening exposing the emergency release area, in which a symbol for the release is visible;

FIG. 6a depicts a representation corresponding to FIG. 5 with the sliding bolt locked;

FIG. 6b depicts a detailed view of detail A from FIG. 6a, showing the locked state of the sliding bolt;

FIG. 6c depicts a schematic detailed view of the window opening that releases the emergency unlocking area, in which a symbol for the lock is visible;

FIG. 7a depicts a schematic diagram of a front view of a locking element with an emergency release actuating element of the sliding bolt, which is in the charging plug locking position;

FIG. 7b depicts a schematic detailed view of the window opening exposing the emergency release area, in which a symbol for the lock is visible;

FIG. 7c depicts a schematic diagram corresponding to FIG. 7a with an emergency release actuating element of the sliding bolt pivoted out of the charging plug locking position;

FIG. 7d depicts a partial section through the locking element along line C-C in FIG. 7c in conjunction with an uncut top view of the sliding bolt in the charging plug release position shown in FIG. 7c;

FIG. 7e depicts the view according to FIG. 7d, with the slide bolt moved to the charging plug release position;

FIG. 7f depicts a schematic detailed view of the window opening releasing the emergency release area, in which a symbol for the release is visible.

### DETAILED DESCRIPTION OF THE INVENTION

As used throughout the present disclosure, unless specifically stated otherwise, the term “or” encompasses all possible combinations, except where infeasible. For example, the expression “A or B” shall mean A alone, B alone, or A and B together. If it is stated that a component includes “A, B, or C”, then, unless specifically stated otherwise or infeasible, the component may include A, or B, or C, or A and B, or A and C, or B and C, or A and B and C. Expressions such as “at least one of’ do not necessarily modify an entirety of the following list and do not necessarily modify each member of the list, such that “at least one of “A, B, and C” should not be understood as including only one of A, only one of B, only one of C, or any combination of A, B, and C.

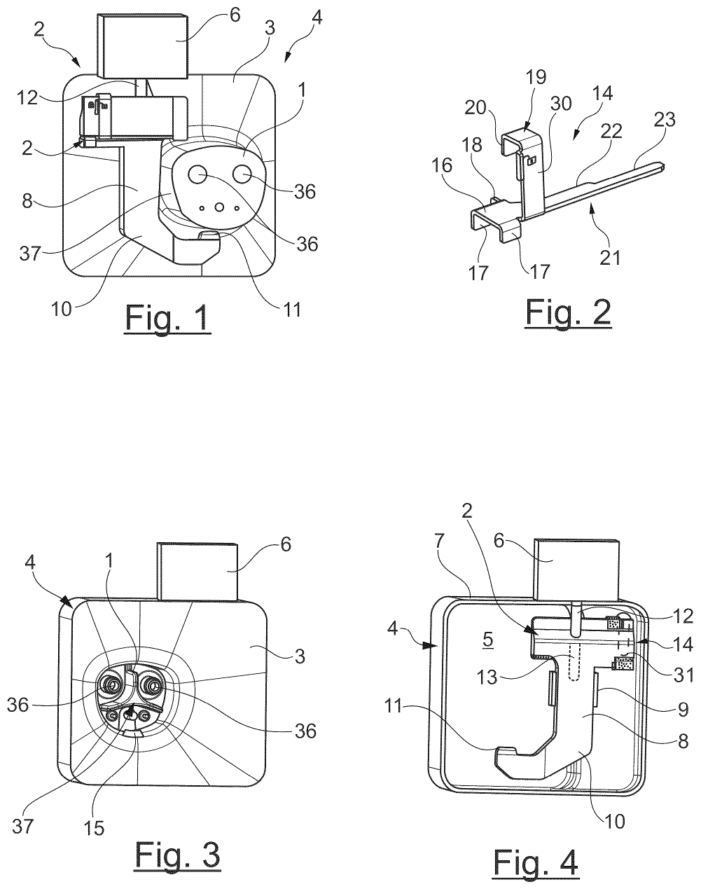

FIG. 1 shows a schematic perspective partial view of an exemplary embodiment of a charging socket 1 with a locking device 2. The charging socket 1 has a charging socket housing 4 with a charging socket front side having plug contacts 36. The front of the charging socket is formed here by a front wall 3, which is shown in FIG. 1 in a rear view.

FIG. 2 is a perspective view of an emergency release connecting element, shown here as an example in the form of a sliding bolt 14, which is explained in more detail below in connection with its function.

FIG. 3 shows the cartridge case housing 4 with its front wall 3 and the cartridge 1 in a front view.

FIG. 4 shows the interior of the charging socket housing 4 without the front wall 3, but with the locking device 2 already mounted on a rear wall 5 of the charging socket housing 4.

An actuator 6 is mounted on a wall or upper wall 7 of the charging socket housing 4, which is located at the top in relation to the shown position of use of the charging socket 1 and viewed in the vertical axis direction, and thus above a locking element 8. The locking element 8 is specifically formed here by an actuator rod.

The locking element 8, which is designed as an actuator rod, is guided vertically in a linear guide or linear rod guide 9 for vertical displacement in the vertical axis direction and, as can be seen in FIG. 1, is also arranged here, for example, laterally adjacent to a receiving area 37 of the front wall 3 for a charging plug of a charging cable not shown here. The receiving area 37, which is designed in the manner of a can or a can body, also has the plug contacts 36 on the front side.

As can be seen from FIG. 1, the locking element 8 engages with the receiving area 37 of the charging socket 1 with a hook area 10, wherein a socket engagement nose projecting upwardly is formed at the end of the hook area 10 as a locking element 11.

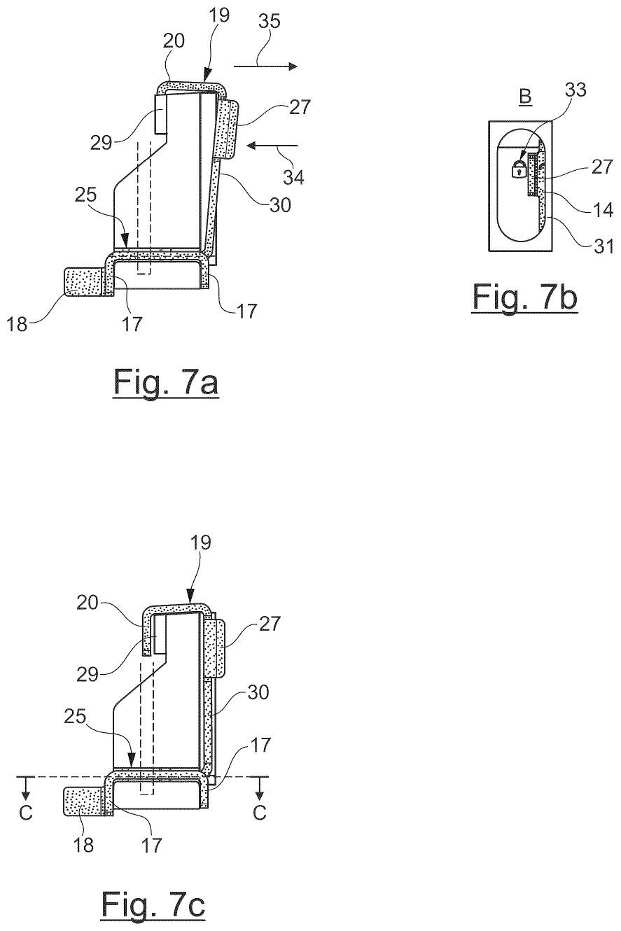

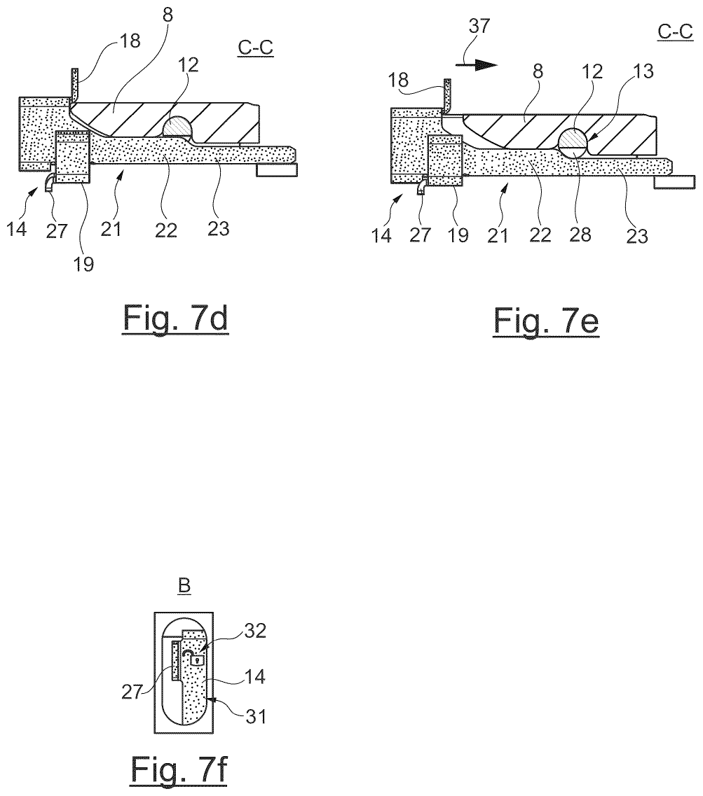

An actuator element 12, shown here as an actuator pin, projects downward from the actuator 6 and can be activated by means of an electronic control device. It engages in a vertical receiving opening 13 of the locking element 8. The locking element 8 and the actuator element 12 are also connected to each other by the emergency release connecting element 14 (see FIG. 2), which is designed as a sliding bolt and will be explained in more detail below, particularly in connection with FIGS. 7a to 7f.

In the fully assembled state of the locking device 2, when the actuator 6 is activated, the actuator element 12 and thus the locking element 8 connected thereto are pulled upward, whereby the locking element 11 is displaced upward through a recess 15 on the underside of the receiving area 37 (see FIG. 3) into the receiving area 37 of the charging socket and engages in an associated locking counter-element of the (not shown) charging plug for locking.

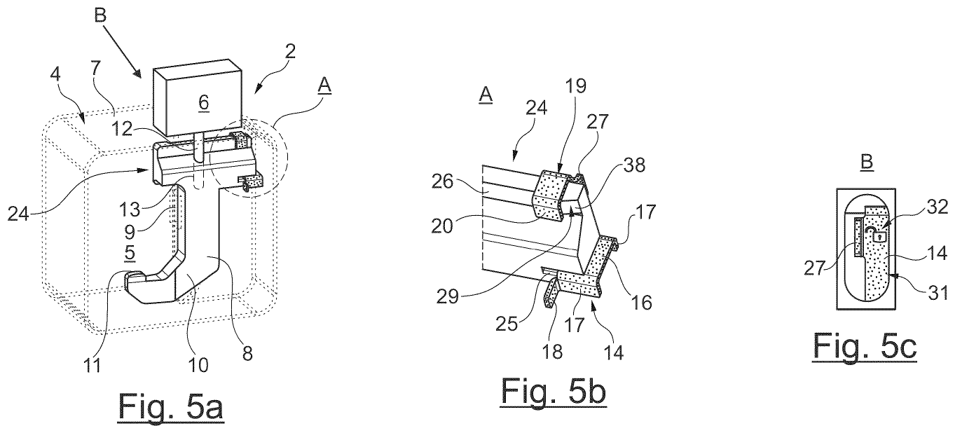

The detachable connection between the actuator element 12 and the locking element 8 is explained in more detail below with reference to FIGS. 5 to 7 with associated detailed views.

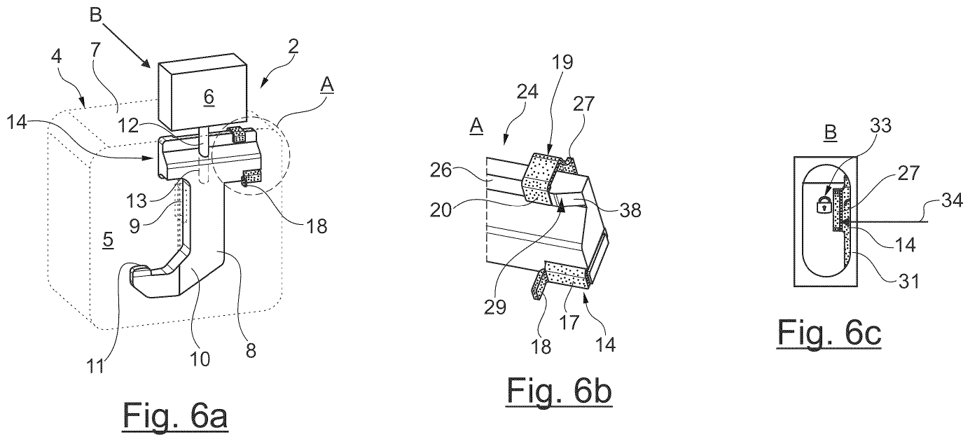

FIG. 5a with detailed drawings 5b and 5c and FIG. 6a with detailed drawings 6b and 6c correspond to a perspective view with further details of FIG. 4, wherein FIG. 5a shows a pre-assembly state with the slide bolt 14 in a charging plug release position without any connecting function, which also corresponds to an emergency release position. In FIG. 6a, on the other hand, the slide bolt is shown in the charging plug locking position with a connection established between the actuator element 12 and the locking element 8.

As can be seen in FIG. 2, in the example shown here, the sliding bolt 14 has a sliding bolt slide section 16 with side guide elements 17 pointing downwards at each side and a mounting element 18, designed here as a handle element, for manual handling or displacement. Adjacent to the sliding bolt slide section 16, an emergency release actuating element 19 extends upward in relation to the vertical axis and is provided at the end with a bent U-leg 20 to form an upper U-shaped guide. Adjacent to the slide bolt slide section 16 is a bolt part 21, which is flat in this example and has a first section 22 and a second section 23 that is narrower than the first section 22.

An upper region of the locking element 8 is designed as a horizontal guide part region 24, the right-hand part of which, in the plane of FIG. 5a, is surrounded by a dotted circle A and shown enlarged in FIG. 5b. The sliding bolt 14 is held on the locking element 8 with its sliding bolt slide section 16 guided in a guide groove 25 and is clearly not yet fully inserted into the guide groove 25 as far as the stop. The emergency release actuating element 19 engages the guide section 24 from behind and from above on a guide web 26 with a U-shaped leg 20. In the example shown here, an emergency release tool attachment 27 is also arranged on the emergency release actuating element 19 toward the rear wall 5, with which at least part of the work necessary for emergency release can be carried out. The sliding bolt 14 is therefore clearly held in a functionally secure and displaceable manner on the locking element 8, so that an overall robust connection of the components can be achieved.

As can also be clearly seen in FIG. 5a in conjunction with FIG. 2, in the example shown here, the mounting element 18 is also attached opposite the emergency release tool attachment 27 for manual displacement during the assembly of the loading box 1 or the locking device 2.

The assembly of the locking device 2 is explained in more detail below, in particular in conjunction with FIGS. 5b, 7c, and 7e, wherein FIG. 7c shows a front view of the state according to FIG. 5b, which also corresponds to a pre-assembly state, while FIG. 7e shows the state of FIG. 7c in a top view. This FIG. 7e clearly shows that when the slide bolt 14 is not or not completely inserted into the guide groove 25, the flat bolt part 21 does not cover the receiving opening 13 in the locking element 8 with its second, narrower section 23 and leaves it free, which corresponds to a “ ” slide bolt release position, so that the actuator element 12 can be inserted or pushed into the receiving opening 13 from above.

If the slide bolt 14 is now moved to the right in accordance with FIG. 7e in the example shown here, in accordance with arrow 37, the first section 22 of the bolt part 21, which is wider than the second section 23 of the bolt part 21, engages in a bolt recess 28, which is shown here as a horizontally extending cross groove, as shown in FIG. 7e. This locks the actuator element 12 firmly but releasably to the locking element 8. In order to carry out this displacement or movement, a worker can grasp the sliding bolt 14 on the mounting element 18 and easily move or shift it into the sliding bolt connection position or final mounting position shown in FIG. 7d, which corresponds to the charging plug locking position.

The guide groove 25 and/or the latch recess 28 are dimensioned, for example, so that they form a stop in the charging plug locking position shown in FIG. 7d.

In order to hold the sliding bolt 14 securely in the final assembly position or charging plug locking position shown in FIG. 7d, which is also shown in FIG. 6b, a locking lug 29 for the U-shaped leg 20 is also provided on the guide web 26 in the specific example shown here, by means of which the emergency release actuating element 19 is releasably locked to the locking element 8 in the charging plug locking position.

Specifically, in the example shown here, the emergency release actuating element 19 is spring-biased away from the guide web 26 or away from the locking element 8 with an upward-pointing leg 30 (see arrow 35), so that the U-leg 20 can be pushed over a ramp 38 during assembly when the sliding bolt 14 is moved into its final assembly position and then engages behind a locking lug 29 which is connected to the ramp 38 or forms the ramp 38, as shown in FIG. 6b and FIG. 7a. FIGS. 5b and 7c accordingly show a state prior to engagement.

For emergency release to release a charging plug (not shown here) from the charging socket 1, for example in the event of a malfunction of the actuator 6 and a locking device 2 located in the charging plug locking position, the pre-assembly state shown in FIG. 5a is restored in order to release the connection between the locking element 8 and the actuator element 12 so that the locking element 8 can fall down to release the engagement of the blocking element 11.

For this purpose, in the example shown here, a window-like opening 31 is provided in the rear wall 5 of the charging socket housing 4 in the area of the emergency release actuating element 19 or the emergency release tool attachment 27 as an emergency release access, which is shown only schematically and in dashed lines in FIG. 4. In addition, the window-like opening 31, which is shown here only as an example in the form of a long hole, is shown in FIGS. 5c, 6c, 7e, and 7f, which show an enlarged detailed view of this area corresponding to a viewing direction in the direction of arrow B (see FIG. 5a).

When the sliding bolt 14 is inserted, establishing a connection between the actuator element 12 and the locking element 8 and thus placing the locking device 2 in the final assembly position or in the charging plug locking position, a marking 33 is visible in the window-like opening 31, as shown in FIGS. 6c and 7b, a marking 33 is visible in the window-like opening 31, namely, here, only as an example, a closed lock as a symbol for the connection established.

In the context of an emergency release, the emergency release actuating element 19 or its leg 30 can now be reached through the window-like opening 31 using a tool, such as a screwdriver, and actuated (see FIG. 7b). However, in order to be able to move the sliding bolt 14 by means of or with the aid of the emergency release tool attachment 27, the locking on the locking lug 29 must first be released by applying a pressure force in the direction of the arrow 34 to the emergency release actuating element 19 or its leg 30 with the tool (see FIG. 7a) so that the emergency release actuating element 19 and thus also the U-leg 20 are displaced relative to the locking element 8 against the elastic biasing force of the emergency release actuating element 19, thereby lifting the U-leg 20 over the locking nose 29 (see FIG. 7c). The sliding bolt 14 can now be moved by means of the tool, preferably with the aid of the emergency release tool attachment 27, so that the connection between the actuator element 12 and the locking element 8 is released. This allows the locking element 8 to fall downwards in the charging socket housing 4 under its own weight, which in turn displaces the locking element 11 downwards out of the charging socket 1, thereby releasing an inserted charging plug.

In FIG. 7f, the position of the slide bolt 14 when the connection between the actuator element 12 and the locking element 8 is no longer established is now indicated by a mark 32, which is shown here only as an example in the form of an open lock.

Since the devices and methods described in detail above are examples of embodiments, they can be modified to a wide extent by the skilled person in the usual manner without leaving the scope of the invention. In particular, the mechanical arrangements and the proportions of the individual elements with respect to each other are merely exemplary.

What is claimed is:

1. A locking device configured to lock a charging plug in a charging socket, the locking device comprising:
at least one locking element configured and arranged to move into a charging plug locking position wherein the at least one locking element releasably locks a charging plug inserted into a charging socket, wherein the at least one locking element is further configured and to move into a charging plug release position wherein the at least one locking element releases the charging plug for release from the charging socket;
an electronically actuable actuator configured and arranged to move the at least one locking element between the charging plug locking position and the charging plug release position; and
an emergency release device configured and arranged to move the at least one locking element independently of actuator actuation at least from the charging plug locking position to the charging plug release position.

2. The locking device according to claim 1, wherein the emergency release device is further configured to move the at least one locking element independently of actuator operation both from the charging plug locking position into the charging plug release position and from the charging plug release position into the charging plug locking position.

3. The locking device according to claim 1, wherein:
the actuator further comprises a displaceable actuator element arranged to enable joint displacement of the actuator element and at least one locking element between the charging plug release position and the charging plug locking position by means of an emergency release connecting element of the emergency release device,
the locking element is configured to move into an emergency release position in which a connection between the actuator element and the at least one locking element is released by means of a locking element for the joint displacement of the actuator element and the locking element by means of an emergency release connection element of the emergency release device,
wherein the emergency release connection element is further configured to be moved into an emergency release position in which the connection between the actuator element and the locking element is released and the locking element is enabled to move into the charging plug release position.

4. The locking device according to claim 1, wherein:
the charging socket further comprises a charging socket housing with a charging socket front side having plug contacts, and
at least one of the actuator and the at least one locking element is arranged on the charging socket housing.

5. The locking device according to claim 3, wherein the charging socket housing further comprises at least one emergency release access through which the emergency release connecting element is accessible for actuation.

6. The locking device according to claim 3, wherein at least one of the actuator and the actuator element is arranged at the top, bottom or side of the cartridge relative to the position of use of the cartridge.

7. The locking device according to claim 6, wherein:
at least one of the actuator and the actuator element is arranged above the locking element relative to the position of use of the charging socket and a vertical axis direction, and
the locking element is configured and arranged to be guided downwardly from at least one of the actuator and the actuator element so as to engaged under a receiving area of the charging socket which receives the charging plug such that the locking element releasably locks an inserted charging plug from below and the locking element is enabled to be moved downward in the emergency release position after being released from the actuator element or falling downward essentially automatically.

8. The locking device according to claim 3, wherein the emergency release connecting element comprises a sliding bolt held in at least one of a displaceable manner and mounted on the locking element, and which, in a sliding bolt connecting position, is configured and arranged to connect the actuator element to the locking element so as to enable joint displacement and be displaced into a slide bolt release position corresponding to the emergency release position in order to release the connection between the actuator element and the locking element.

9. The locking device according to claim 8, wherein the emergency release connecting element further comprises a mounting element configured to be engaged in order to pre-position the emergency release connecting element on at least one of the locking element and to move the emergency release connecting element into the slide bolt connecting position.

10. The locking device according to claim 8, wherein the emergency release connecting element is further configured as a sliding bolt and is held and/or mounted in a guide groove of the locking element so as to enable its displacement.

11. The locking device according to claim 8, wherein the emergency release connecting element is configured as a sliding bolt with an emergency release actuating element.

12. The locking device according to claim 11, further comprising at least one marking arranged on at least one of the emergency release actuating element and the locking element, wherein the at least one marking is arranged on at least one of the emergency release actuating element and on the locking element and is configured to visually indicate a position of the emergency release connecting element which is configured as a sliding bolt in the charging plug locking position or in the charging plug release position.

13. The locking device according to claim 11, wherein:
the sliding bolt is configured and arranged to be held immovably on the locking element and thus in the slide bolt connection position;
the emergency release actuating element in the assembled basic state is configured and arranged to be held on the locking element such that it can be displaced in a relative displacement direction not corresponding to the displacement direction of the slide bolt or against an elastic biasing force; and
the emergency release actuating element is configured and arranged to be held the locking element such that it can be displaced in a relative displacement direction not corresponding to the displacement direction of the slide bolt or against an elastic biasing force in a relative displacement direction not corresponding to the sliding bolt displacement direction; and
wherein the emergency release actuating element is further configured such that, when a relative displacement of the emergency release actuating element relative to the locking element is effected on the emergency release actuating element or preferably by overcoming the elastic preload, the sliding bolt is displaced by means of the locking element relative to the locking element so as to release the displacement of the sliding bolt by means of the emergency release actuating element into the sliding bolt release position.

14. A charging socket, comprising a locking device comprising at least one locking element configured and arranged to move into a charging plug locking position wherein the at least one locking element releasably locks a charging plug inserted into a charging socket, wherein the at least one locking element is further configured and to move into a charging plug release position wherein the at least one locking element releases the charging plug for release from the charging socket; an electronically actuable actuator configured and arranged to move the at least one locking element between the charging plug locking position and the charging plug release position; and an emergency release device configured and arranged to move the at least one locking element independently of actuator actuation at least from the charging plug locking position to the charging plug release position.

15. A method for actuating a locking device configured to lock a charging plug in a charging socket, the method comprising the steps of:
providing at least one locking element configured to be moved into a charging plug locking position in which the at least one locking element releasably locks a charging plug inserted into the charging socket, and which is further configured to be moved into a charging plug release position in which the at least one locking element releases the charging plug for release from the charging socket,
providing an electronically actuable actuator configured to move the at least one locking element between the charging plug locking position and the charging plug release position, and
providing an emergency release device by means of which the at least one locking element is moved from the charging plug locking position to the charging plug release position independently of actuator actuation for emergency release.
